(19) United States
(12) Patent Application Publication
(10) Pub. No.: US 2006/0159777 A1
(43) Pub. Date: Jul. 20, 2006

(54) Aqueous acaricidal solution

(75) Inventors: Jean-Philippe Pascal, Nancy (FR); Nicolas Palangie, Varese (IT)

Correspondence Address: OBLON, SPIVAK, MCCLELLAND, MAIER & NEUSTADT, P.C., 1940 DUKE STREET, ALEXANDRIA, VA, 22314, US

(73) Assignee: SOLVAY (SOCIETE ANONYME), Bruxelles (BE)

(21) Appl. No.: 10/539,564

(22) PCT Filed: Dec. 18, 2003
(86) PCT No.: PCT/EP03/14523

§ 371 Date: Mar. 27, 2006

(30) Foreign Application Priority Data
Dec. 19, 2002 (FR) 0216447

(51) Int. Cl. A01N 59/00

(52) U.S. Cl. 424/717

(57) ABSTRACT

Acaricidal aqueous solution comprising from 10 to 100 g/l of sodium bicarbonate. Use of this aqueous solution for treating elements of the human environment.

The invention relates to an acaricidal aqueous solution. It also relates to the use of such an aqueous solution.

The term “acaricidal aqueous solution” is intended to mean an aqueous solution that brings about the death of acarids. The acarids can be in egg form, larvae form or adult form. The action of the aqueous solution can be direct. It can also be indirect, for example when the acaricidal aqueous solution destroys a substance that is necessary for survival of the acarid.

Acarids are small arachnids, close to a tenth of a millimetre in size, that develop in particular in bedding and carpeting in homes and that are capable of causing allergic reactions in human beings. Their optimum living conditions require a humidity of between 55 and 85% and a temperature of between 15 and 35° C. Acarids feed essentially on the squamae and organic substances that accumulate in thick textiles. A human adult losses on average 1.5 g of dead skin a day, which is sufficient to feed 1.5 million acarids.

It is known and widespread practice to combat acarids by means of pyrethrum and of synthetic pyrethrinoids, such as permethrin. These substances are neurotoxic and their harmfulness to humans is being increasingly established.

Pyrethrinoid substitutes, which are not harmful to humans, are demanded by many users.

Furthermore, for the treatment of textiles in the human environment, acaricidal compositions in powdered form are difficult to apply evenly and it is difficult to get them to penetrate to the heart of the textile.

The invention is directed towards providing an aqueous solution that is natural and harmless to humans and that makes it possible to eliminate acarids simply, effectively and economically.

Consequently, the invention relates to an acaricidal aqueous solution comprising at least 10 g/l of sodium bicarbonate.

Sodium bicarbonate is a product that is reputed to be harmless to humans. It is even authorized by various bodies (such as FDA in the United States) in human food.

It has been observed that the acarids do not absorb the acaricidal aqueous solution in accordance with the invention, and that, when the water evaporates, the sodium bicarbonate crystallizes in the form of extremely fine grains. These fine grains adhere to the outer surface of the acarids. Without wishing to be bound by a theoretical explanation and without excluding other modes of action, the inventor thinks that the grains of bicarbonate damage certain membrane exchange equilibria of the cuticle of the acarid and of the shell of the egg, which is thought to induce dehydration and in the end death thereof.

The acaricidal aqueous solution comprises at least 10 g/l of sodium bicarbonate. There is no need for it to comprise more than 100 g/l. It is recommended for it to comprise at least 30 g/l of sodium bicarbonate, preferably 40 g/l. It is advantageous for the aqueous solution to comprise no more than 80 g/l of sodium bicarbonate, preferably 60 g/l. Acaricidal aqueous solutions comprising from 40 to 60 g/l of sodium bicarbonate are particularly suitable.

In an advantageous embodiment of the invention, the aqueous solution comprises no other acaricidal substance. The only acaricidal active substance is therefore the sodium bicarbonate. In particular, the aqueous solution contains no neurotoxic substance such as pyrethrum or permethrin.

The invention also relates to the use of the aqueous solution in accordance with the invention described above, for its acaricidal effects, in particular for treating elements of the human environment.

The term “elements of the human environment” is intended to mean the interior elements of buildings in which humans live, such as offices or homes. In particular, this relates to the material elements with which humans are in contact and that are favourable to the development of acarids. These elements comprise, for example: bedding (mattresses, pillows, textiles for bedding), rugs, carpets, armchairs, textiles for various clothes, soft toys or fleeces. The aqueous solution in accordance with the invention which is natural and harmless to humans is particularly suitable for treating rugs, carpets and textiles for bedding and clothes.

In the use according to the invention, it is essential for the aqueous solution in accordance with the invention to penetrate correctly into the texture to be treated. It may in particular be applied by brushing, sprinkling or immersion.

In a first advantageous embodiment of the use according to the invention, the aqueous solution is applied by sprinkling. The sprinkling consists in forming very fine droplets and in projecting them onto the element to be treated. The sprinkling may be aided by the expansion of a gas, which improves the projection of the droplets. It is then commonly called “spray”. The amount of acaricidal aqueous solution to be applied, per square metre, can vary according to the nature of the surface to be treated. It has been observed that amounts of at least 10 ml/m², preferably 40 ml/m², are generally necessary. However, it is, on rare occasions, advantageous to apply amounts greater than 100 ml/m², or even 60 ml/m². The use of amounts ranging from 40 to 60 ml/m² is recommended.

In a second advantageous embodiment, the aqueous solution is applied to the element to be treated by immersion of the latter in the aqueous solution. In this embodiment, the immersion time should be sufficient to ensure correct penetration of the aqueous solution into the element to be treated.

The following examples illustrate in a non-limiting manner the effectiveness of the aqueous solution in accordance with the invention for combating acarids.

### EXAMPLE 1

Acarids (dermatophagoides pteronyssinus) originating from a laboratory strain raised on a substrate consisting of a 50/50 (mass/mass) mixture of wheatgerm and of brewer's yeast as flakes calibrated by sieving (fragments of less than 1 mm in size) were used. The temperature was between 23 and 25° C. and the relative humidity was maintained at 75% by placing in the presence of a saturated aqueous ammonium sulphate solution ([NH₄)₂SO₄]); the strain was conserved in the dark.

Pieces of standard cotton wool (150 g/m²) were pre-infested with approximately 200 acarids of all stages.

The pieces of cotton wool were then treated by sprinkling with an aqueous solution obtained by mixing 10, 30 or 50 g/l of sodium bicarbonate into water.

Two rates of application of the solution were used: 30 and 50 ml/m².

The sodium bicarbonate solution was sprayed and projected evenly and precisely over the cotton wool surfaces.

The mortality of the acarids was noted after 15 min, 1 h, 2 h, 4 h and 24 h.

A control batch of acarids was monitored in parallel so as to determine the natural mortality of the acarids subjected to spraying with the same volume of water.

Each experimental series was repeated three times and the means of the mortality results obtained were taken.

The following results were observed:

EXAMPLE 1
BICARBONATE IN SOLUTION - CURATIVE EFFECT

| | | | Contact time | | | | |
|---|---|---|---|---|---|---|---|
| | | | 15 | 1 | 2 | 4 | 24 |
| | | | minutes | hour | hours | hours | hours |
| | | Amount of | % | % | % | % | % |
| Concentration | Application rate | bicarb/m² | mortality | mortality | mortality | mortality | mortality |
| 10 g bicarb/1 | 30 ml (water + bicarb)/ | i.e. 0.3 g | 0.0 | 0.0 | 0.2 | 0.5 | 18.5 |
| | m² | bicarb/m² | | | | | |
| 10 g bicarb/1 | 50 ml (water + bicarb)/ | i.e. 0.5 g | 0.0 | 0.0 | 2.1 | 20.9 | 35.8 |
| | m² | bicarb/m² | | | | | |
| 30 g bicarb/1 | 30 ml (water + bicarb)/ | i.e. 0.9 g | 0.0 | 0.0 | 0.0 | 0.7 | 19.7 |
| | m² | bicarb/m² | | | | | |
| 30 g bicarb/1 | 50 ml (water + bicarb)/ | i.e. 1.5 g | 0.0 | 0.0 | 3.4 | 25.1 | 39.9 |
| | m² | bicarb/m² | | | | | |
| 50 g bicarb/1 | 30 ml (water + bicarb)/ | i.e. 1.5 g | 0.0 | 0.0 | 0.0 | 5.2 | 88.0 |
| | m² | bicarb/m² | | | | | |
| 50 g bicarb/1 | 50 ml (water + bicarb)/ | i.e. 2.5 g | 0.0 | 0.0 | 2.8 | 58.9 | 95.7 |
| | m² | bicarb/m² | | | | | |
| Control | 30 ml (water + bicarb)/ | i.e. 0 g | 0.0 | 0.0 | 0.0 | 0.0 | 16.9 |
| | m² | bicarb/m² | | | | | |
| Control | 50 ml (water + bicarb)/ | i.e. 0 g | 0.0 | 0.0 | 4.3 | 19.9 | 33.8 |
| | m² | bicarb/m² | | | | | |

This example, in which the piece of cotton wool is infested with acarids before being treated, illustrates the curative acaricidal effect of the solution in accordance with the invention.

### EXAMPLE 2

The procedure was carried out as in example 1, except that the acaricidal aqueous solution was not applied by sprinkling, but the pieces of standard cotton wool (150 g/m²) were immersed in baths of sodium bicarbonate solution.

Three sodium bicarbonate concentrations were used: 10, 30 and 50 g/l.

After drying of the textiles, approximately 200 acarids of all stages were deposited thereon and the acarid mortality was measured as a function of time.

The acarid mortality was noted after 3 and 6 weeks.

Each experimental series was also repeated three times and the means of the mortality results obtained were taken.

The following results were observed:

| Example 2 | | |
|---|---|---|
| Sodium bicarbonate | After 3 weeks | After 6 weeks |
| concentration | Survivors | Survivors |
| 10 g/l | 212.8 | 818.3 |
| 30 g/l | 153.5 | 245.0 |
| 50 g/l | 53.5 | 143.0 |
| Control | 236.0 | 895.3 |

This example, in which the piece of cotton wool is infested acarids after having been treated, illustrates the preventive acaricidal effect of the solution in accordance with the invention.

1-10. (canceled)

11. An acaricidal aqueous solution comprising at least 10 g/l of sodium bicarbonate, wherein the acaricidal aqueous solution is free of any other acaricidal substance.

12. The solution according to claim 11, comprising from 10 to 100 g/l of sodium bicarbonate.

13. The solution according to claim 12, comprising from 40 to 60 g/l of sodium bicarbonate.

14. The solution according to claim 11, wherein the acaricidal aqueous solution is free of neurotoxic substances.

15. A method for treating elements of the human environment comprising applying the acaricidal aqueous solution according to claim 11 to elements of the human environment.

16. The method according to claim 5, wherein the elements of the human environment consist of rugs and carpets.

17. The method according to claim 15, wherein the elements of the human environment consist of textiles for bedding or clothing.

18. The method according to claim 15, wherein the aqueous solution is applied by sprinkling.

19. The method according to claim 15, wherein an amount of solution of 40 to 60 ml/m² is applied.

20. The method according to claim 15, wherein the treatment is carried out by immersion in the aqueous solution.
